(19) United States
(12) Patent Application Publication
(10) Pub. No.: US 2016/0207187 A1
(43) Pub. Date: Jul. 21, 2016

(54) Drilling Device

(71) Applicant: HITACHI KOKI CO., LTD., Tokyo (JP)

(72) Inventors: Tomomasa Nishikawa, Hitachinaka, Ibaraki (JP); Chikai Yoshimizu, Hitachinaka, Ibaraki (JP); Nobuhiro Takano, Hitachinaka, Ibaraki (JP)

(21) Appl. No.: 14/915,388

(22) PCT Filed: Jul. 25, 2014
(86) PCT No.: PCT/JP2014/069710

§ 371 Date: Feb. 29, 2016

(30) Foreign Application Priority Data
Aug. 30, 2013 (JP) 2013-178933

(51) Int. Cl. B25D 16/00

(52) U.S. Cl. CPC B25D 16/006

(57) ABSTRACT

A drilling device capable of easily pulling an end bit out of a workpiece is provided. The drilling device is provided with a housing, a brushless motor, a motion translating mechanism, and an output portion. The motion translating mechanism includes a rotation transmitting portion. The rotation transmitting portion includes a bevel gear and clutch. The bevel gear has an abutment portion. The clutches has an abutted portion. Rotational play is formed between the abutment portion and the abutted portion.

### TECHNICAL FIELD

The present invention relates to a drilling device, and more particularly to a drilling device operable in three modes including a rotation mode, an impact mode, and a rotation/impact mode.

### BACKGROUND ART

Conventionally, drilling devices operable in three modes have been proposed. An end bit, such as drill, is detachably attached to the drilling device for performing drilling operations to a workpiece, such as concrete, stone.

### CITATION LIST

### Patent Literature

PTL 1: Japanese Patent Application Publication No. 2006-142459

### SUMMARY OF INVENTION

### Technical Problem

With the above-described drilling device, there is a difficulty in pulling the end bit out of the drilled hole after the drilling operation is complete, as the end bit and the drilled hole are in locked (or galling) condition. In order to resolve such a problem, there has been proposed a drilling device provided with a guide that keeps an end bit and a hole drilled thereby in parallel entirely during the drilling operation. A problem arises in doing so in that time to set the guide is needed and the drilling device becomes large in size due to the provision of the guide.

An object of the invention is to provide a drilling device capable of easily pulling the end bit out of the workpiece.

### Solution to Problem

In order to attain above and other object, the present invention provides an drilling device. The drilling device includes a housing, a motor, and rotary motion transmitting portion. The motor is provided in the housing and is rotatable in forward direction and reverse direction, the forward rotation and the reverse rotation being repeatedly performed in case of forward/reverse mode. The rotary motion transmitting portion is configured to transmit a rotational force of the motor to an end bit. The rotary motion transmitting portion includes a rotary member, an abutment portion, and an abutted portion. The rotary member is rotationally driven by the motor. The abutment portion is provided at the rotary member and is rotatable together with the rotary member. The abutted portion is rotationally driven upon abutment with the abutment portion during repetition of the forward rotation and the reverse rotation of the motor in the forward/reverse mode.

According to the above configuration, in the forward/reverse mode, the end bit is repeatedly rotated forward and reverse directions. Accordingly, even when the end bit and a workpiece are temporarily brought to a locked (or galling) condition, the end bit can be easily pulled out of the workpiece by setting to the forward/reverse mode. Consequently, enhanced workability of the drilling device can be attained.

Preferably, the abutment portion and the abutted portion are positioned away from each other in a circumferential direction of the rotary member in at least one of a first rotational direction of the rotary member when the motor is rotated in the forward direction and a second rotational direction of the rotary member when the motor is rotated in the reverse direction.

In this configuration, rotational play is formed between the abutment portion and the abutted portion. Therefore, the drilling device is not swung about the end bit even when the motor is driven under the forward/reverse mode in a state where the end bit and the workpiece are temporarily in the locked condition. In other words, even when the rotations of the motor 3 are rebounded on the entire drilling device as a reaction force caused by the locked end bit, the reaction force rebounded on the drilling device can be reduced by virtue of the rotational play formed between the abutment portion and the abutted portion. Consequently, the end bit can be easily pulled out of the workpiece and thus enhanced workability can be attained. Further, the abutment portion impacts the abutted portion, thereby temporarily transmitting a strong rotational force to the end bit. Thus, the locked condition of the end bit can be quickly released.

Preferably, the rotary motion transmitting portion further includes a deceleration portion configured to deceleratingly transmit rotation of the motor to the rotary member.

By the above configuration, decelerated rotations of the motor are transmitted to the rotary member. Therefore, a quantity of the rotational play can be suppressed smaller in comparison with a configuration in which a rotational play is provided in the upstream side of the rotation transmission route of the deceleration portion. Consequently, a large space for providing a large quantity of the rotational play is not required, and thus upsizing of the drilling device can be suppressed.

Preferably, the drilling device further includes a reciprocal motion translating portion configured to translate the rotational force of the motor into a reciprocal motion. The reciprocal motion translating portion includes a reciprocation member and a cylinder. The reciprocation member is configured to impact the end bit. The cylinder accommodates therein the reciprocation member. The rotary member and the abutted portion are positioned radially outward of the cylinder. The abutted portion is movable in an axial direction of the cylinder, and is configured to transmit or shut-off the rotational force to the cylinder upon the axial movement.

In the above configuration, since the abutted portion and the rotary member are provided outward of the cylinder in the radial direction, bearings are unnecessary as is not the case in which the rotational play is provided in the deceleration portion. Therefore, the rotational play can be provided on the driving force transmission route from the motor to the end bit by a simple structure.

Preferably, the drilling device further includes a trigger, a switch, and a change-over dial. The trigger is configured to turn on/off a power supply to the motor. The switch is configured to change an operation mode to the forward/reverse mode. The change-over dial is configured to selectively provide one of an impact mode, a rotation mode, and an impact/rotation mode. In the impact mode, only an impacting force is transmitted to the end bit by the reciprocal motion translating portion. In the rotation mode, only a rotational force is transmitted to the end bit by the rotary motion transmitting portion. In the impact/rotation mode, the impacting force and the rotational force is transmitted to the end bit. The motor is operated in the forward/reverse mode by manipulating the switch and pulling the trigger while the change-over dial is at the rotation mode.

With this configuration, the motor can be driven under the forward/reverse mode only when the change-over dial is at the rotation mode. Thus, in the forward/reverse mode, impacting actions are not performed. Consequently, idle impacting can be prevented during the forward/reverse mode, thereby reducing a load imposed on the motor.

Preferably, the drilling device further includes a change-over dial configured to selectively change an operation mode to one of an impact mode, a rotation mode, an impact/rotation mode, and a forward/reverse mode. In the impact mode, only an impacting force being transmitted to the end bit by the reciprocal motion translating portion. In the rotation mode, only a rotational force being transmitted to the end bit by the rotary motion transmitting portion. In the impact/rotation mode, the impacting force and the rotation force being transmitted to the end bit.

In this configuration, a user can easily set the operation mode to the forward/reverse mode by switching the change-over dial.

Preferably, the housing includes a main body portion and a handle portion. The main body accommodates therein the motor and the rotary motion transmitting portion. The handle portion is movable relative to the main body portion. The drilling device further includes a detecting portion and a controller. The detecting portion is configured to detect movement of the handle portion. The controller is configured to set the operation mode to the forward/reverse mode in accordance with a result of detection by the detecting portion.

By the above configuration, the controller sets the operation mode to the forward/reverse mode in response to the movement of the handle portion relative to the main body portion. Therefore, the forward/reverse mode can be automatically set in response to the detection of pulling the end bit out of the workpiece by the user.

Preferably, the detecting portion includes a load sensor.

With this configuration, movement of the handle portion can be detected with certainty because the detecting portion is the load sensor.

Preferably, the detecting portion includes a position sensor.

With this configuration, movement of the handle portion can be detected with certainty because the detecting portion is the position sensor.

Preferably, the motor is a brushless motor.

### Advantageous Effects of Invention

The invention provides an drilling device capable of easily pulling an end bit out of a workpiece.

### BRIEF DESCRIPTION OF DRAWINGS

FIG. 1 is a cross-sectional view of a hammer drill according to a first embodiment of the present invention.

FIGS. 2A-2D are cross-sectional views taken along a II-II line of the hammer drill according to the first embodiment of the present invention.

FIG. 3 is a control diagram of the hammer drill according to the first embodiment of the present invention.

FIG. 4 is a cross-sectional view as viewed from above of the hammer drill according to the first embodiment of the present invention in a state where a switching dial is at a rotation mode.

FIG. 5 is a cross-sectional view as viewed from above of the hammer drill according to the first embodiment of the present invention in a state where the switching dial is at an impact mode.

FIG. 6 is a cross-sectional view as viewed from above of the hammer drill according to the first embodiment of the present invention in a state where the switching dial is at an rotation/impact mode.

FIG. 7 is an operational flowchart of the hammer drill according to the first embodiment.

FIG. 8. is a cross-sectional view of a hammer drill according to a second embodiment of the present invention.

FIG. 9 is an external view of a hammer drill according to a third embodiment of the present invention.

FIG. 10 is a control diagram of a hammer drill according to a modification of the embodiments of the present invention.

### DESCRIPTION OF EMBODIMENTS

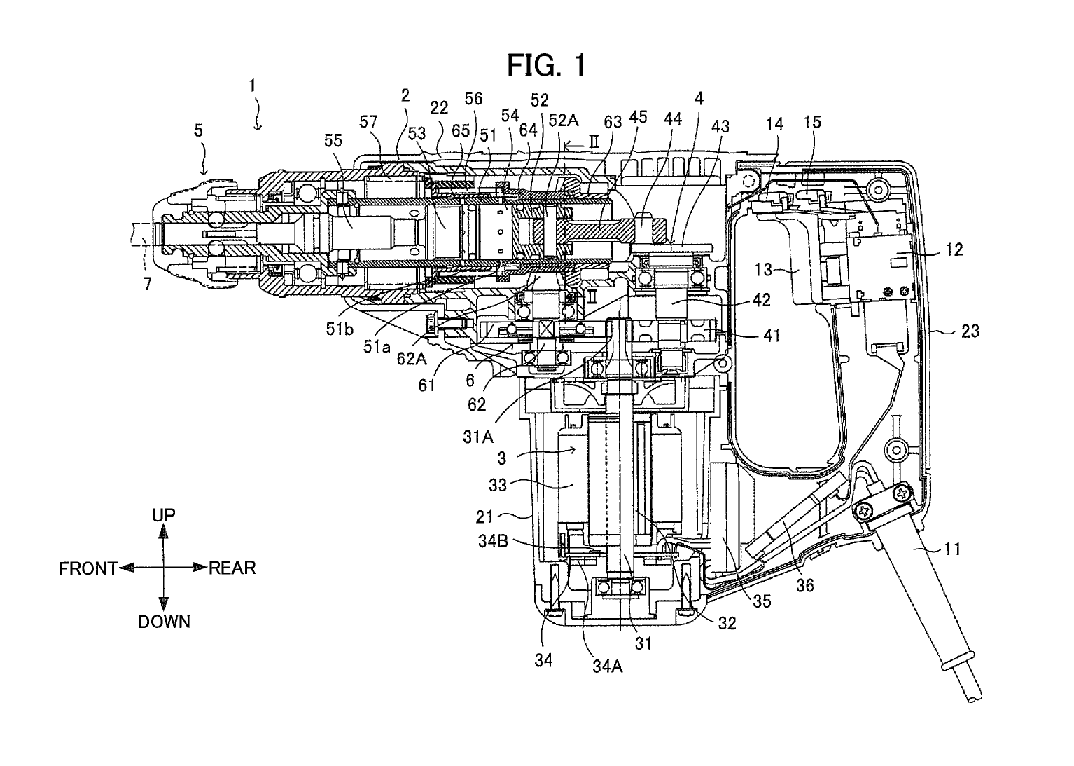

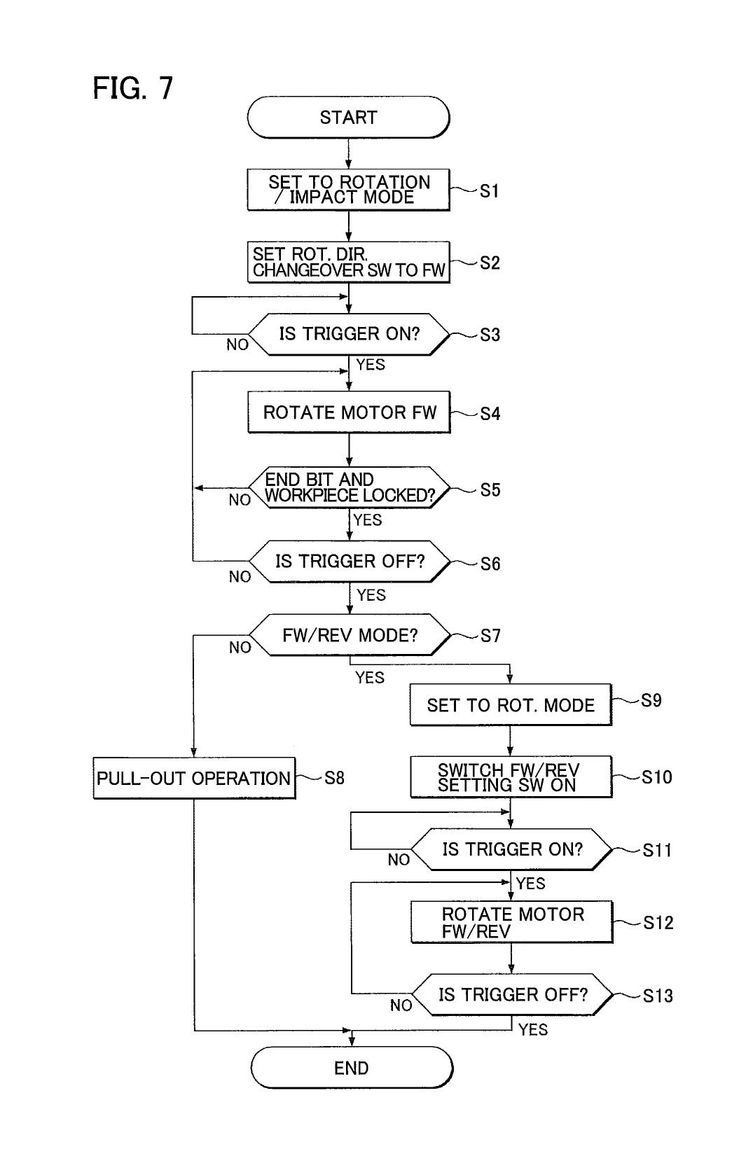

A drilling device according to first embodiment of the present invention will be described with reference to FIGS. 1 and 7. FIG. 1 is a cross-sectional view illustrating a hammer drill 1 which is representative of the drilling device. The hammer drill 1 is provided with a housing 2, a brushless motor 3, a motion translating mechanism 4, an output portion 5. In the following description, a direction from the motion translating mechanism 4 to the output portion 5 will be referred to as “frontward direction”, and a direction opposite thereto will be referred to as “rearward direction.” Also, a direction from the motion translating mechanism 4 to the brushless motor 3 will be referred to as “downward direction”, and a direction opposite thereto will be referred to as “upward direction.” Further, “rightward direction” and “leftward direction” will be used when viewing the hammer drill 1 from a rear side thereof in FIG. 1.

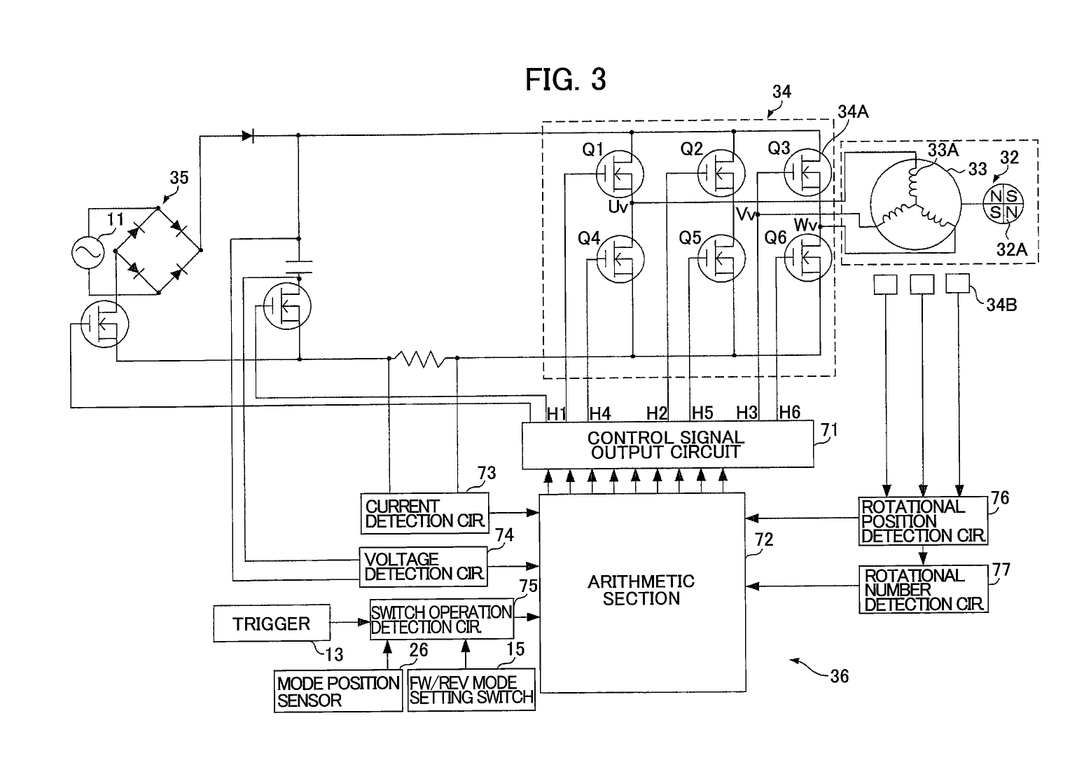

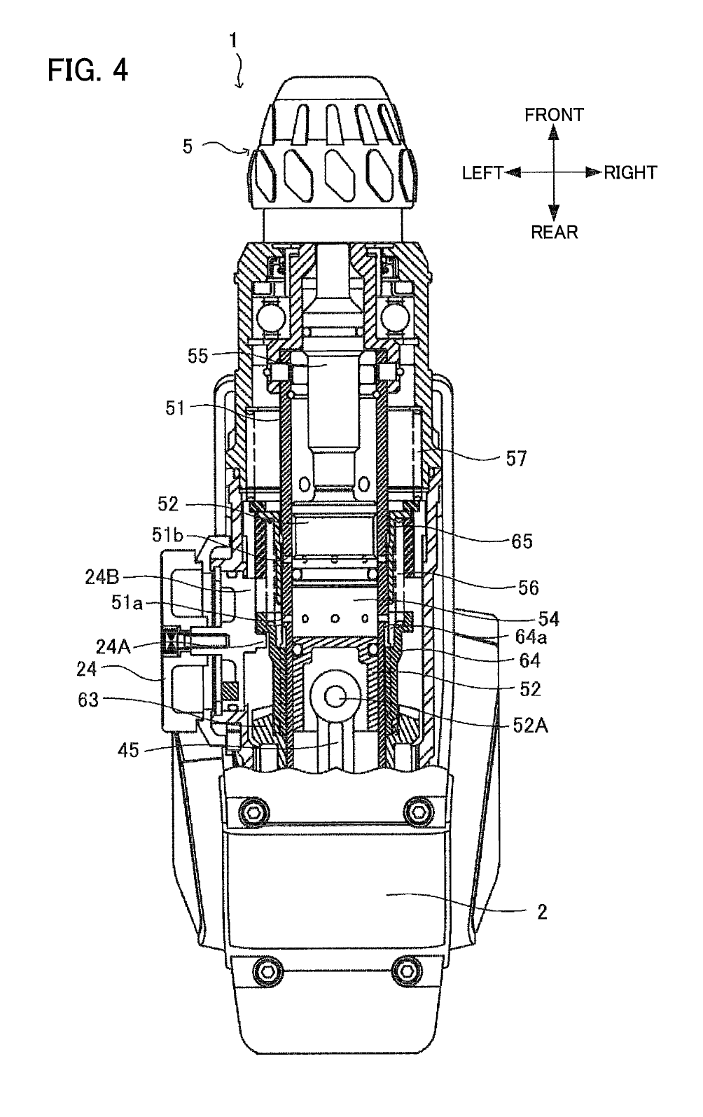

The housing 2 includes a motor housing 21, a main body 22, a handle portion 23 connected to both the motor housing 21 and the main body 22. The motor housing 21 extends downward from the main body 22 and accommodates the brushless motor 3. The main body 22 accommodates the motion translating mechanism 4, and has a upper rear end portion connected to the handle portion 23. The main body 22 has a left side surface provided with a switching dial 24 for changing operation mode of the hammer drill 1. The switching dial 24 is adapted to be rotatable relative to the main body 22 (FIG. 4). A user can switch the operation mode to either one of a rotation mode, impact mode, rotation/impact mode, and neutral mode by manipulating the switching dial 24. The switching dial 24 is provided with a mode position sensor 26 (FIG. 3) detecting a rotational position of the switching dial 24. As illustrated in FIG. 4, the switching dial 24 includes a first pressing portion 24A protruding toward an inside of the housing 2, and a second pressing portion 24B. Operation of the hammer drill 1 in each of the operation modes will be described later in detail.

The handle portion 23 is provided with a power cable 11, and accommodates a switch mechanism 12. The switch mechanism 12 is mechanically connected to a trigger 13 that can be manipulated by the user. The power cable 11 is adapted to connect the switch mechanism 12 to an external power source (not illustrated). When the power cable 11 is connected to the external power source, connection of the brushless motor 3 to the external power source can be switched to disconnection of the brushless motor 3 from the external power source, and vice versa, can be accomplished by manipulating the trigger 13. A rotational direction changeover switch 14 for setting a rotation direction of the brushless motor 3 is disposed upward of the trigger 13. A forward/reverse mode setting switch 15 for setting the operation mode of the hammer drill 1 to a forward/reverse mode is disposed rearward of the rotational direction changeover switch 14.

The brushless motor 3 is provided with an output shaft 31. The output shaft 31 extends in the upward/downward direction, and outputs rotational driving force. The output shaft 31 is coaxially fixed to a rotor 32 having a permanent magnet 32A (FIG. 3). A stator 33 is disposed outside the rotor 32 so as to face the rotor 32, and includes a plurality of windings 33A. An inverter circuit 34 is provided below the stator 33, and is provided with a plurality of FETs 34A and a Hall element 34B. The plurality of FETs 34A or six FETs are mounted on the lower surface of the inverter circuit 34 (FIG. 3). The Hall element 34B is provided at a position facing the permanent magnet 32A in the upward/downward direction on the upper surface of the inverter circuit 34. The output shaft 31 has a distal end portion provided with a pinion gear 31A. The pinion gear 31A is meshingly engaged with the motion translating mechanism 4.

A full-wave rectifier circuit 35 and a control board 36 are accommodated in a connection portion positioned rearward of the brushless motor 3 and connecting the handle portion 23 and the motor housing 21. The full-wave rectifier circuit 35 is adapted to full-wave rectify AC power from the external power source into DC power. The full-wave rectifier circuit 35 is electrically connected to the control board 36 and the inverter circuit 34. Configurations of the full-wave rectifier circuit 35 and the control board 36 will be described later in details. The control board 36 is an example of claimed “a controller.”

The motion translating mechanism 4 includes a first gear 41, a crank shaft 42, a crank weight 43, a crank pin 44, a connecting rod 45, and a rotation transmitting portion 6. The first gear 41 is coaxially fixed to the crank shaft 42, and is meshingly engaged with the pinion gear 31A. The crank shaft 42 is disposed rearward of the output shaft 31 so as to extend in the upward/downward direction, and is rotatably supported to the main body 22. The crank weight 43 is fixed to the upper end of the crank shaft 42. The crank pin 44 extends upward from the crank weight 43 and is fixed to the end portion thereof The crank pin 44 is inserted into the rear end portion of the connecting rod 45. The crank shaft 42, the crank weight 43, and crank pin 44 are integrally formed by machining, but not limited to this. A part of these components (for example, the crank pin 44) may be formed separately from remaining parts, and then they may be combined. The motion translating mechanism 4 is an example of claimed “a deceleration portion.”

Within the main body 22, a cylinder 51 having a substantially cylindrical shape extending in a direction perpendicular to the output shaft 31 (the frontward/rearward direction) is provided. The cylinder 51 is formed with a plurality of first breathing holes 51a arranged in a circumferential direction, and a plurality of second breathing holes 51b positioned frontward of the plurality of the first breathing holes 51a. Within the cylinder 51, a piston 52 slidably movable in the frontward/rearward direction is provided. The piston 52 includes a piston pin 52A inserted into the front end portion of the connecting rod 45. An impact member 53 is disposed at the front portion of the interior of the cylinder 51. The impact member 53 is slidably movable (reciprocally movable) relative to the inner surface of the cylinder 51. In the cylinder 51, an air chamber 54 is defined between the piston 52 and the impact member 53. An intermediate member 55 is provided frontward of the impact member 53. The intermediate member 55 is impacted by the impact member 53, transmitting the impact force to an end bit 7. In the following description, a radial direction of the cylinder 51 will be simply referred to as “radial direction.” Also, a circumferential direction of the cylinder 51 will be simply referred to as “circumferential direction.” Further, an axial direction of the cylinder 51 will be simply referred to as “axial direction.” The piston 52, the impact member 53, and the intermediate member 55 are examples of claimed “a reciprocation member.”

The rotation transmitting portion 6 includes a second gear 61, a rotation transmitting shaft 62, a bevel gear 63, and a clutch 64. The second gear 61 is disposed at the opposite side of the first gear 41 with respect to the output shaft 31, and is meshingly engaged with the pinion gear 31A. The second gear 61 is coaxially fixed to the rotation transmitting shaft 62. The rotation transmitting shaft 62 is provided frontward of the output shaft 31, and extends the upward/downward direction. The rotation transmitting shaft 62 is rotatably supported to the main body 22. The rotation transmitting shaft 62 has an upper portion provided with a gear portion 62A meshingly engaged with the bevel gear 63. When rotation of the brushless motor 3 is transmitted to the bevel gear 63 via the second gear 61 and the gear portion 62A, rotational number of the brushless motor 3 is reduced. That is, in the rotation transmitting portion 6, the bevel gear 63 is a final reduction portion in which the rotational number of the brushless motor 3 is brought into the smallest number. The bevel gear 63 is an example of claimed “a rotary member.” Note that, in the present embodiment, gear ratios are set such that approximately five impacting actions are performed during one rotation of the end bit 7.

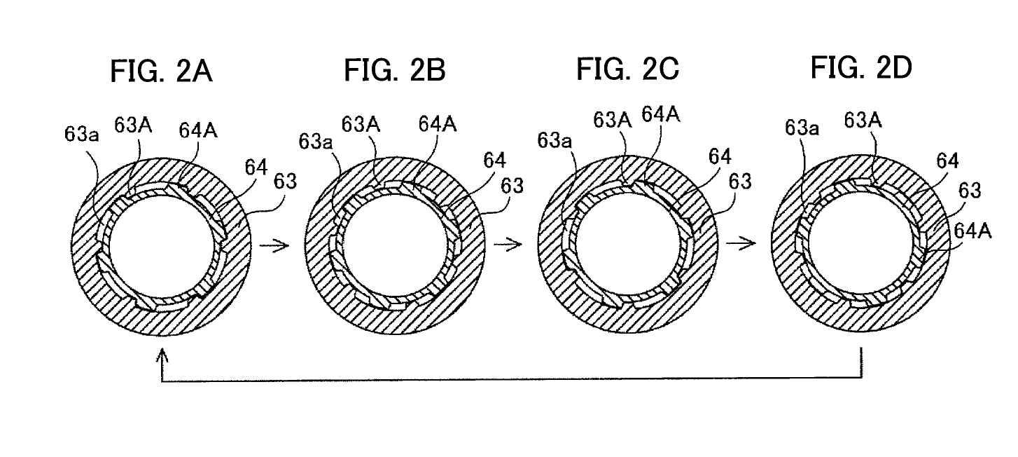

The bevel gear 63 is provided at the rear portion of the cylinder 51, and covers the outer peripheral surface thereof. The bevel gear 63 is rotatably supported to the cylinder 51 so as to be rotatable relative thereto. As illustrated in FIG. 2, the bevel gear 63 is formed with a plurality of recessed portions 63a and a plurality of abutment portions 63A. Each of the recessed portions 63a is recessed outward in the radial direction. Each of the abutment portions 63A is disposed between the neighboring recessed portions 63a, and protrudes inward in the radial direction. A length of the abutment portion 63A in the circumferential direction is shorter than that of the recessed portion 63a. In the present embodiment, the six abutment portions 63A are provided at an equal interval (an angle of approximately 60 degrees) in the circumferential direction. Each of the abutment portions 63A is capable of abutting against a relevant abutted portion 64A described later.

The clutch 64 is provided frontward of the bevel gear so as to be movable in the frontward/rearward direction. The clutch 64 rotates together with the cylinder 51. As illustrated in FIG. 4, the clutch 64 is urged rearward by a first spring 56. The clutch 64 has a rear end portion provided with the plurality of abutted portions 64A. The abutted portions 64A are capable of abutting on the abutment portions 63A (FIG. 2). The abutted portions 64A are provided at an equal interval (an angle of approximately 60 degrees) in the circumferential direction so as to correspond to the six abutment portions 63A. Each of the abutted portions 64A protrudes outward in the radial direction. An outward-protruding amount of the abutted portion 64A in the radial direction is approximately equal to an inward-protruding amount of the abutment portion 63A in the radial direction. A length of the abutted portion 64A in the circumferential direction is longer than that of the abutment portion 63A. As illustrated in FIGS. 2A and 2C, each of the abutment portions 63A is configured to abut the relevant abutted portion 64A at the same time. The abutment portions 63A and the abutted portions 64A provide a so-called rotational play, and the rotation of the brushless motor 3 is transmitted to the cylinder 51 via the rotational play. The clutch 64 has a rear potion formed with a receiving portion 64a recessed inward in the radial direction. The receiving portion 64a is capable of receiving a moving member 65 described later.

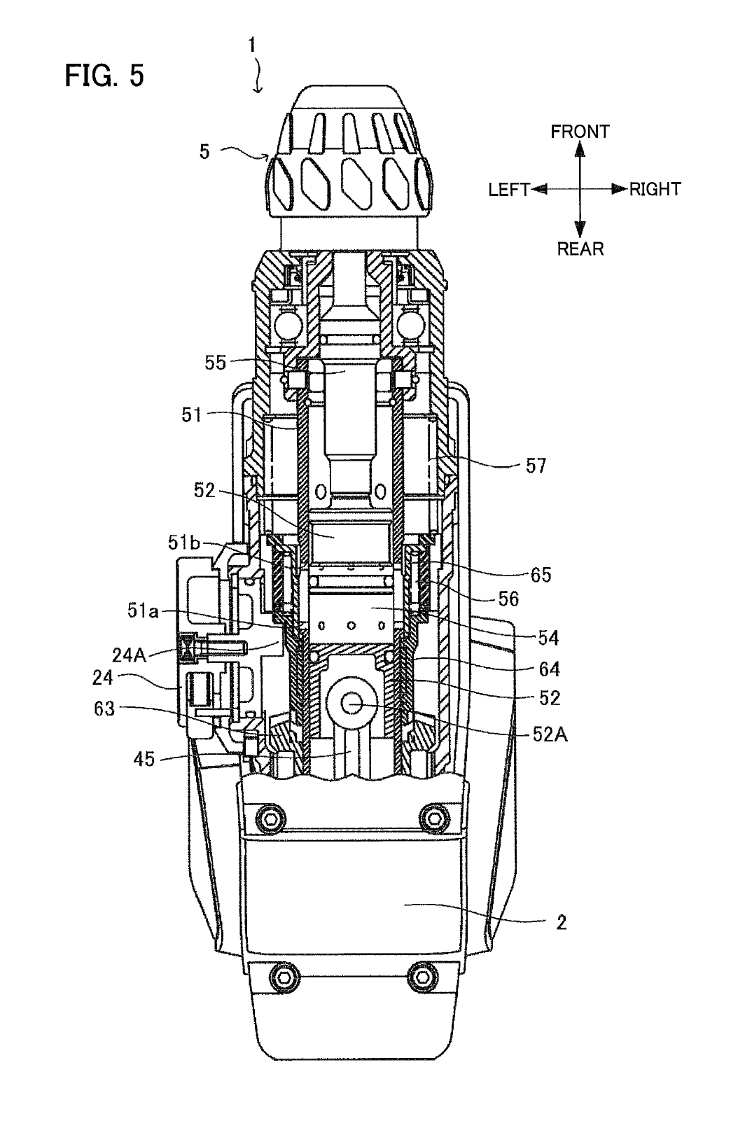

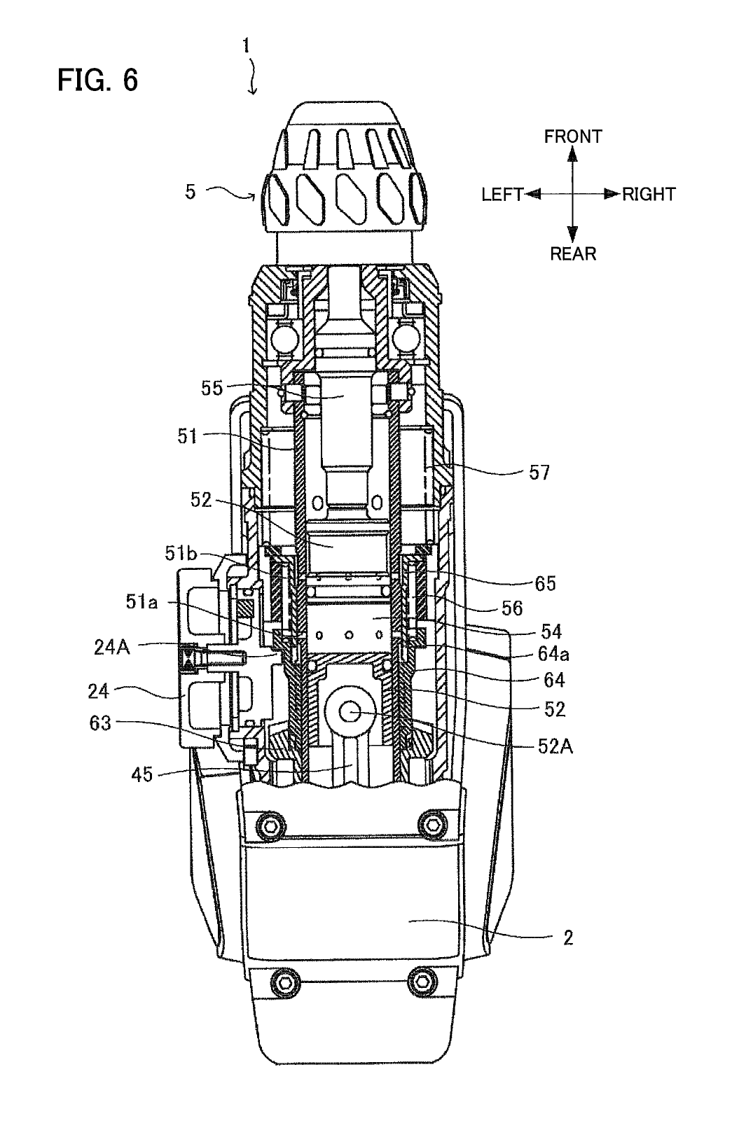

The moving member 65 is disposed frontward of the clutch 64. The moving member 65 has a substantially cylindrical shape, and covers the outer peripheral surface of the cylinder 51. The moving member 65 is movable in the axial direction, and is urged rearward by a second spring 57. The rear end portion of the moving member 65 opens and closes the first breathing holes 51a (FIGS. 5 and 6) by the movement of the moving member 65 in the frontward/rearward direction.

The output portion 5 is provided frontward of the main body 22, and is configured to attachably and detachably hold the end bit 7.

Next, description with respect to control of the brushless motor 3 will be made while referring to the block diagram illustrated in FIG. 3.

In this embodiment, a three-phase brushless DC motor is employed as the brushless motor 3. The permanent magnet 32A of the rotor 32 includes plural sets of N-pole and S-pole (two sets in this embodiment). The windings 33A include star-connected windings U, V and W. In response to a position detection signal fed from the Hall element 34B disposed in confrontation with the permanent magnet 32A, controlled are a direction to energize each of the windings U, V and W and a period of time during which each of the windings U, V and W is energized.

The FET bridge 34A includes six switching elements Q1 through Q6 connected to form a three-phase bridge. Each of the six switching elements Q1 through Q6 of this bridge-connection has a gate connected to a control signal output circuit 71. Either drain or source of each of the six switching elements Q1 through Q6 is connected to the relevant windings U, V or W of the star-connection. By virtue of such connections, the six switching elements Q1 through Q6 perform switching actions in response to switching element drive signal (drive signals H4, H5, H6 etc.), thereby producing three-phase (U-phase, V-phase and W-phase) voltages Vu, Vv and Vw from the full-wave rectified DC voltage produced by the full-wave rectifier circuit 35 and powering the fixed windings U, V and W with the three-phase DC voltages thus produced.

Among switching element drive signals (three-phase signals) for driving the gates of six switching elements Q1 through Q6, three drive signals H4, H5 and H6 in the form of a pulse width modulation signal (PWM signals) are applied to three switching elements Q4, Q5 and Q6 connected to the negative power source line side. The pulse width or duty ratio of the PWM signal is changed by an arithmetic section 72 mounted on the control board 36 in response to a detection signal based upon an operation amount or stroke of the trigger 13. In this way, power supply to the brushless motor 3 is adjusted and start/stop and rotational speed control of the brushless motor 3 are carried out.

The PWM signals are alternately applied to a set of the switching elements Q1 through Q3 and to another set of switching elements Q4 through Q6 at a time. The former set of the switching elements is connected to the positive power source line side on the inverter circuit 34 whereas the latter set of the switching elements is connected to the negative power source line side on the inverter circuit 34. The two sets of the switching elements are alternately switched at a high speed. In this way, power supplied to the respective windings U, V and W is controlled on the basis of the DC voltage supplied from the full-wave rectifier circuit 35.

Mounted on the control board 36 are the control signal output circuit 71, the arithmetic section 72, a current detection circuit 73, a voltage detection circuit 74, a switch operation detection circuit 75, a rotational position detection circuit 76, and a rotational number detection circuit 77. Although not illustrated in the drawing, the arithmetic section 72 includes a central processing unit (CPU) for generating the drive signals based on a processing program and its associated data, a ROM for storing the processing program, control data and various kinds of threshold values, and a RAM for temporarily storing data.

The arithmetic section 72 configured to generate control signals for alternately switching on the switching elements Q1 through Q6 on the basis of the output signals fed from the rotational position detection circuit 76, and to output the control signals to the control signal output circuit 71. As a result, current alternately flows in the windings U, V and W, causing the rotor 32 to rotate in a preset rotational direction. In this case, the drive signals applied to the switching elements Q4 through Q6 connected to the negative power source line are outputted as a PWM signal based on the output control signals from the switch operation detection circuit 75. The values of the current and voltage applied to the brushless motor 3 are measured by the current detection circuit 73 and the voltage detection circuit 74, respectively, and the values thus measured are fed back to the arithmetic section 72. The arithmetic section 72 operates to adjust the current and voltage values so that the drive power and current are brought into agreement with the preset values. The PWM signals may be applied to the switching elements Q1 through Q3 connected to the positive power source line.

The switch operation detection circuit 75 is configured to output control signals to the arithmetic section 72 in response to the operation of the trigger 13. The switch operation detection circuit 75 further configured to output signals to the arithmetic section 72 in response to the signals fed from the forward/reverse mode setting switch 15 and the mode position sensor 26. In this embodiment, the brushless motor 3 is driven under the forward/reverse mode only when the mode position sensor 26 detects that the switching dial 24 indicates the rotation mode and the forward/reverse mode setting switch 15 is operated. In the forward/reverse mode, the brushless motor 3 is sequentially and repeatedly driven in such a way that it rotates forward for 40 msec, stops for 10 msec, rotates backward for 40 msec, and then stops for 10 msec. The period of time during which the brushless motor 3 rotates forward, stops, or rotates backward is not limited to the values mentioned above. These values can be properly adjusted depending upon the structure of the rotational play or the rotational number of the brushless motor 3.

The arithmetic section 72 detects the rotational number of the brushless motor 3 on the basis of the signals fed from the rotational position detection circuit 76 and the rotational number detection circuit 77.

Next, mode switching and operation of the hammer drill 1 will be described with reference to FIG. 6.

The hammer drill 1 according to the present embodiment is configured to change operation mode to be switchable to the rotation mode, impact mode, rotation/impact mode, and neutral mode by manipulating the switching dial 24. FIG. 4 shows that the switching dial 24 is set to the rotation mode. In the rotation mode, only rotations of the cylinder 51 are transmitted to the end bit 7. Specifically, the clutch 64 and bevel gears 63 are engaged with each other via rotational play. At this time, the second pressing portion 24B presses the moving member 65 against the urging force imparted thereupon by the second spring 57 to thereby move the moving member 65 backward. Attendant to the backward movements of the moving member 65, the first breathing holes 51a are brought to open. When the user pulls the trigger 13 under the condition described, the brushless motor 3 starts rotating, and the rotational force is transmitted to the cylinder 51 via the rotation transmitting portion 6. Specifically, the rotational driving force of the brushless motor 3 is transmitted to the pinion gear 31A, the second gear 61 and the rotation transmitting shaft 62. Rotations of the rotation transmitting shaft 62 are transmitted to the gear portion 62A and the bevel gear 63. Further, the abutment portion 63A of the bevel gear 63 and the abutted portion 64A are brought into abutment with each other, thereby transmitting the rotations of the bevel gear 63 to both the clutch 64 and the cylinder 51. Rotations of the cylinder 51 produces rotational force that is imparted upon the end bit 7. Because the first breathing holes 51a is open, the reciprocal movements of the piston 52 are not transmitted to the impact member 53.

FIG. 5 shows the switching dial 24 set to the impact mode. In the impact mode, only the impact force transformed from the reciprocal movements of the piston 52 is transmitted to the end bit 7. Specifically, the first pressing portion 24A presses the clutch 64 to move rearward against the urging force imparted thereupon by the first spring 56. The rearward movements of the clutch 64 make the bevel gear 63 and the clutch 64 to be disengaged one from the other. Further, the moving member 65 moves forward by virtue of the urging force imparted thereupon by the second spring 57, thereby closing the first breathing holes 51a. When the end bit 7 is pressed against a workpiece (not shown), the impact member 53 and the intermediate member 54 are retracted rearward. Then, the second breathing holes 51b are closed by the impact member 53, thereby making the air chamber 54 be a hermetically sealed air space. Pulling the trigger 13 rotates the brushless motor 3 and transmits the rotational force of the brushless motor 3 to the crank shaft 42 via the pinion gear 31A and the first gear 41. Rotations of the crank shaft 42 is translated into reciprocal movements of the piston 52 disposed within the cylinder 51 by virtue of the motion translating mechanism 4 including the crank weight 43, the crank pin 44 and the connecting rod 45.

Reciprocal movements of the piston 52 yield variation in air pressure within the air chamber 54. By the operation of air spring in the air chamber 54, the impact member 53 follows the reciprocal movements of the piston 52 and commences its own reciprocal movements. The impact member 53 is brought into abutment with the intermediate member 54 resulting from reciprocal movements of the impact member 53, and thus the impact force is transmitted to the end bit 7 and the workpiece is crushed. At this time, the bevel gear 63 is disengaged from the clutch 64, so that the rotations of the bevel gear 63 are not transmitted to the cylinder 51.

FIG. 6 shows the switching dial 24 set to the rotation/impact mode. In the rotation/impact mode, the impact force produced by the reciprocal movements of the piston 52 and the rotations of the cylinder 51 are imparted upon the end bit 7. Specifically, the clutch 64 moves forward by the urging force of the first spring 56, and the bevel gear 63 and the clutch 64 are brought into engagement with each other via rotational play. At the same time, the moving member 65 moves forward by the urging force of the second spring 57 to thereby close the first breathing holes 51a. Pulling the trigger 13 under the condition described, both the impact force and rotational force are imparted upon the end bit 7 via the motion translating mechanism 4 and the rotation transmitting portion 6.

The neutral mode is provided for freely setting the rotational position of the end bit 7. For example, when a scoop is employed as the end bit 7, the user is capable of setting the position of the scoop at a desired position.

Next, description will be made with respect to the forward/reverse mode while referring to FIGS. 2 and 4. When crushing concrete using the hammer drill 1, it is often the case that the end bit 7 is caught by a reinforcing steel buried in the concrete and temporarily placed in a locked (or galling) condition. In such a case, the end bit 7 needs to be pulled out of the concrete, however, the end bit 7 may not be easily pulled out due to the galling. The same is true with respect to the case in which the end bit 7 is pulled out of a drilled hole. Under such a condition, the user sets the switching dial 24 to the rotation mode (FIG. 4), sets the forward/reverse mode setting switch 15 to the forward/reverse mode, and then pulls the trigger 13, thereby enabling the hammer drill 1 to operate in the forward/reverse mode. In the forward/reverse mode, the brushless motor 3 repeats a series of forward rotations, stoppage, and reverse rotations at an interval of a short period of time. As shown in FIG. 2, during 40 msec forward rotations, the condition in FIG. 2A shifts to the condition in FIG. 2C, in which the abutment portion 63A impacts the abutted portion 64A, thereby transmitting the rotational force in the forward direction to the end bit 7. After elapse of 10 msec stoppage, the brushless motor 3 reversely rotates for 40 msec. As a result, the condition shown in FIG. 2C is again back to the condition shown in FIG. 2A and the rotational force in the reverse direction is transmitted to the end bit 7. In this manner, due to forward and reverse rotations of the end bit 7 performed at a fixed interval each for a brief period of time, the locked condition of the end bit 7 can easily be brought to an unlocked condition. The range in which the abutment portion 63A is rotated forward and reverse is approximately in a rage of 60 degrees. During the forward and reverse rotational movements of the abutment portion 63A, the rotational amount of the crank shaft 42 is less than one rotation. The gear ratio is set to operate in this way, so that influence adversely exerted upon the impact mechanism can be minimized even if the brushless motor 3 is rotated forward and reverse in the rotation/impact mode. The load imposed upon the impact mechanism at the time of operation in the forward/reverse mode can further be suppressed by the configuration in which the impact mechanism is disabled in the forward/reverse mode as in the present embodiment.

Next, the forward/reverse mode will be described in detail while referring to the flowchart illustrated in FIG. 7. The user sets the switching dial 24 to the rotation/impact mode as shown in FIG. 6 (S1), and the rotational direction changeover switch 14 to the forward direction (S2). Upon completion of such settings, the hammer drill 1 is ready for performing hole forming operations. To this end, the end bit 7 is pressed against the workpiece and then the air chamber 54 is hermetically sealed. Under this condition, the user pulls the trigger 13 (S3: YES) to forwardly rotate the brushless motor 3 (S4). When the end bit 7 and the workpiece are not in a locked condition (S5: NO), the brushless motor 3 continues forward rotations (S4). When the end bit 7 and the workpiece are brought to a locked condition (S5: YES), the user releases the trigger 13 (S6: YES).

For a slight locked condition, i.e., in the case where the end bit 7 is not projected into a deep level of the workpiece and the end bit 7 can easily be pulled out of the workpiece, the user determines that the forward/reverse mode does not need to be implemented (S7: NO) and pulls the hammer drill 1 rearward in order to pull the end bit 7 out of the workpiece (S8).

When the user sees difficulty in releasing the locked condition (S7: YES), the switching dial 24 is set to the rotation mode (S9) and the forward/reverse mode setting switch 15 is turned on (S10). When the trigger is pulled with such settings (S11), the brushless motor 3 repeatedly performs forward and reverse rotations each for a short period of time (S12). After pulling the end bit 7 out of the workpiece can be successfully carried out, the trigger 13 is released and job is finished (S13; YES).

With this configuration, when the operation mode is set to the forward/reverse mode, the end bit 7 is repeatedly rotated forward and reverse directions. Accordingly, even when the end bit 7 and the workpiece are temporarily brought to a locked (or galling) condition, the end bit 7 can be easily pulled out of the drilled hole of the workpiece. Consequently, enhanced workability of the hammer drill 1 can be attained.

In this configuration, the rotational play is formed between the abutment portion 63A and the abutted portion 64A. Therefore, the hammer drill 1 is not swung about the end bit 7 even when the brushless motor 3 is driven under the forward/reverse mode in a state where the end bit 7 and the workpiece are temporarily in the locked condition. In other words, even when the rotations of the brushless motor 3 are rebounded on the hammer drill 1 as a reaction force caused by the locked end bit 7, the reaction force rebounded on the hammer drill 1 can be reduced by virtue of the rotational play formed between the abutment portion 63A and the abutted portion 64A. Consequently, the end bit 7 can be easily pulled out of the drilled hole of the workpiece and thus enhanced workability can be attained. Further, the abutment portion 63A impacts the abutted portion 64A, thereby temporarily transmitting a strong rotational force to the end bit 7. Thus, the locked condition of the end bit 7 can be quickly released.

By the above-described configuration according to this embodiment, the decelerated rotations of the brushless motor 3 are transmitted to the bevel gear 63. Therefore, a quantity of the rotational play can be suppressed smaller in comparison with a configuration in which a rotational play is provided in the upstream side of the rotation transmission route of the rotation transmitting portion 6. Consequently, a large space for providing a large quantity of the rotational play is not required, and thus upsizing of the hammer drill 1 can be suppressed.

In the embodiment, since the abutted portions 64A and the bevel gear 63 are provided outward of the cylinder 51 in the radial direction, bearings are unnecessary as is not the case in which the rotational play is provided in the upstream side of the rotation transmission route of the rotation transmitting portion 6. Therefore, the rotational play can be provided on the driving force transmission route from the brushless motor 3 to the end bit 7 by a simple structure.

With this configuration, the brushless motor 3 can be driven under the forward/reverse mode only when the switching dial 24 indicates the rotation mode. Thus, in the forward/reverse mode, impacting actions are not performed. Consequently, idle impacting can be prevented during the forward/reverse mode, thereby reducing a load imposed on the brushless motor 3.

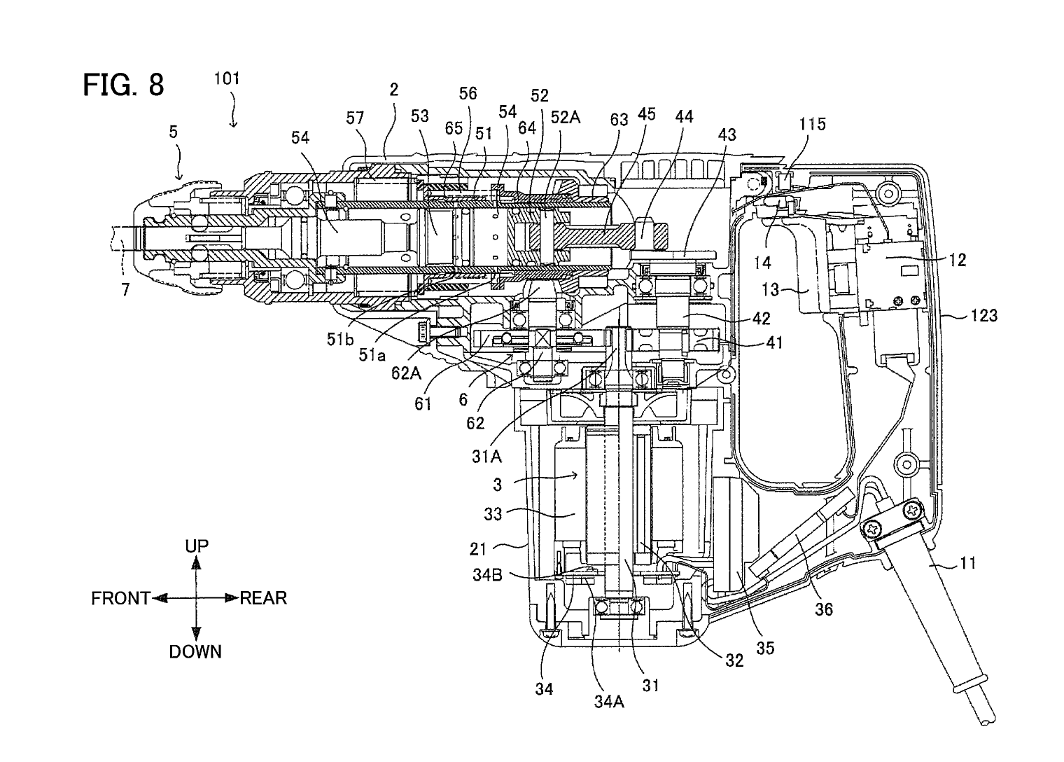

A drilling device according to a second embodiment of the present invention will next be described with reference to FIG. 8 in which like parts and components are designated by the same reference numerals as those shown in the first embodiment for omitting duplicating description.

In a hammer drill 101 according to the second embodiment, a sensor 115 is provided instead of the forward/reverse mode setting switch 15. A handle portion 123 provided in the housing 2 is movable relative to the main body 22. More specifically, the handle portion 123 is pivotally movable about a portion connected to the motor housing 21 (a portion accommodating the control board 36). With this structure, the handle portion 123 and the main body 22 are pivotally movable toward and away from each other in frontward/rearward direction. The sensor 115 is adapted to detect a position of the handle portion 123, and is electrically connected to the switch mechanism 12 and the control board 36. The sensor 115 is an example of claimed “a detecting portion.”

In a normal drilling operation, the handle portion 123 and the main body 22 are adjacent to each other because a user presses the handle portion 123 frontward. When a locked state appears between the end bit 7 and the workpiece, the user returns the trigger 13 and pulls the handle portion 123 backward in order to pull the end bit 7 out of the workpiece. As a result, the handle portion 123 is remote from the main body 22 (the handle portion 123 is pivotally moved). The sensor 115 detects the spaced-away movement of the handle portion 123, and automatically sets the forward/reverse mode. In this state, the brushless motor 3 is driven under the forward/reverse mode when the user pulls the trigger 13. The sensor 115 can be a load sensor or load cell. In the latter case, a structure of the handle portion 123 can be simplified because movable stroke of the handle portion 123 can be reduced. According to the second embodiment, the hammer drill 101 can be operated under the forward/reverse mode irrespective of the operation mode set by the switching dial 24.

With this structure, the control board 36 sets the operation mode to the forward/reverse mode in response to the movement of the handle portion 123 relative to the main body 22. Therefore, the forward/reverse mode can be automatically set in response to the detection of pulling operation of the end bit 7 out of the workpiece by the user.

Further, with this structure, movement of the handle portion 123 can be detected with certainty because the sensor 115 is the position sensor.

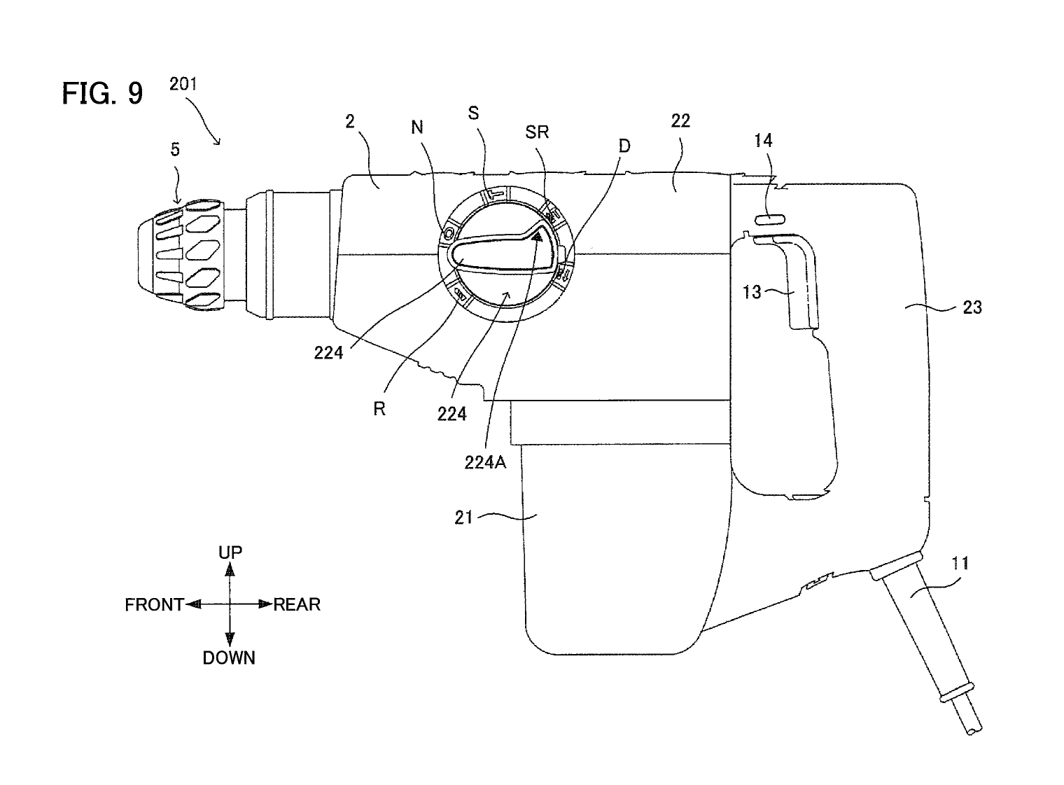

Next, a drilling device according to a third embodiment of the present invention will be described with reference to FIG. 9. Incidentally, like parts and components are designated by the same reference numerals as those shown in the foregoing embodiments for omitting duplicating description.

A switching dial 224 is provided at a right side surface of the main body 22. An arrow 224A is indicated in the switching dial 224, so that the operation mode of a hammer drill 201 can be set by tuning the switching dial 224 to one of the operation modes. In the third embodiment, a forward/reverse mode D is provided in addition to a normal rotation mode R, neutral mode N, impact mode S, rotation/impact mode.

The user can set the hammer drill 201 under the forward/reverse mode by tuning the arrow 224A to the forward/reverse mode D. In the normal/reverse mode, the brushless motor 3 repeatedly performs forward rotation, stop, and reverse rotation without impacting actions.

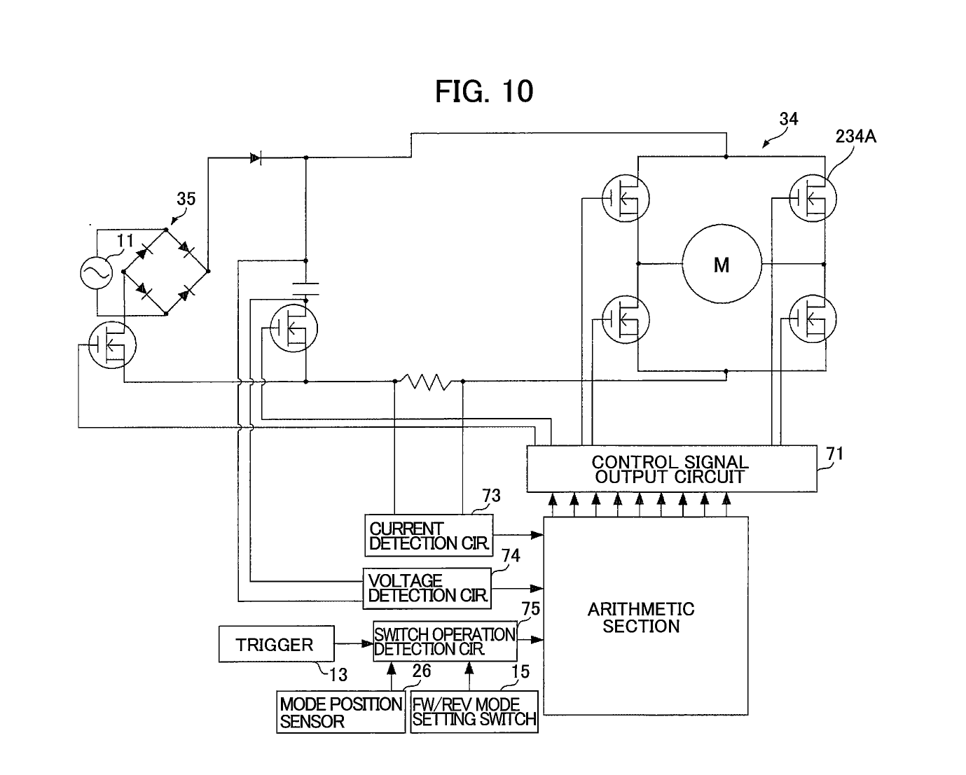

The drilling device according to the present invention is not limited to the above-described embodiments, but various modifications are conceivable without departing from the scope of claims. For example, in the above-described embodiments, the brushless motor 3 as illustrated in FIG. 3 is employed. However, a commutation motor having H-bridged circuit as shown in FIG. 10 is also available. The commutation motor can be rotated in forward and reverse directions by switching four FETs 234A in accordance with a signal fed from the control signal output circuit 71.

In the above-described forward/reverse mode, the brushless motor 3 alternately changes rotational direction such as in the order of forward rotation, reverse rotation, forward rotation and reverse rotation. However, forward rotation and reverse rotation can be changed in different order such as for example, in the order of forward rotation, forward rotation, reverse rotation, and reverse rotation, or in the order of forward rotation, forward rotation, reverse rotation, forward rotation, forward rotation, and reverse rotation.

In the above-described embodiments, six abutment portions 63A are positioned at every 60 degrees. However, the angular positional relationship of the abutment portions 63A is not limited to the embodiments, as long as two abutment portions 63A are provided. However, the abutment portions 63A are preferably arranged in the circumferential direction at an angular interval between neighboring abutment portions 63A equal to each other.

In the above-described embodiments, the switch operation detection circuit 75 drives the brushless motor 3 under the forward/reverse mode only when the forward/reverse mode setting switch 15 is manipulated in a state where the mode position sensor 26 is at the rotation mode. However, the forward/reverse mode setting switch 15 can be manipulated mechanically only when the mode position sensor 26 is at the rotation mode.

In the above-described embodiment, rotational play occurs between the bevel gear 63 and the clutch 64. However, such rotational play can be set between the clutch 64 and the cylinder 51. In the latter case, the clutch 64 is provided with a component corresponding to the abutment portion, and the cylinder 51 is provided with a component corresponding to the abutted portion.

### REFERENCE SIGNS LIST

1, 101, 201: hammer drill, 2: housing, 3: brushless motor, 4: motion translating mechanism, 5: output portion, 6: rotation transmitting portion, 7: end bit, 13: trigger, 15: forward/reverse mode setting switch, 23, 123: handle portion, 36: control board, 53: impact member, 55: intermediate member, 63: bevel gear, 63A: abutment portion, 64A: abutted portion.

1. A drilling device comprising:
a housing;
a motor provided in the housing and rotatable in forward direction and reverse direction, the forward rotation and the reverse rotation being repeatedly performed in case of forward/reverse mode; and
a rotary motion transmitting portion configured to transmit a rotational force of the motor to an end bit, the rotary motion transmitting portion comprising:
a rotary member rotationally driven by the motor;
an abutment portion provided at the rotary member and rotatable together with the rotary member; and
an abutted portion rotationally driven upon abutment with the abutment portion during repetition of the forward rotation and the reverse rotation of the motor in the forward/reverse mode.

2. The drilling device as claimed in claim 1, wherein the abutment portion and the abutted portion are positioned away from each other in a circumferential direction of the rotary member in at least one of a first rotational direction of the rotary member when the motor is rotated in the forward direction and a second rotational direction of the rotary member when the motor is rotated in the reverse direction.

3. The drilling device as claimed in claim 2, wherein the rotary motion transmitting portion further comprises a deceleration portion configured to deceleratingly transmit rotation of the motor to the rotary member.

4. The drilling device as claimed in claim 3, further comprising a reciprocal motion translating portion configured to translate the rotational force of the motor into a reciprocal motion, and comprising:
a reciprocation member configured to impact the end bit; and
a cylinder accommodating therein the reciprocation member, the rotary member and the abutted portion being positioned radially outward of the cylinder;
wherein the abutted portion is movable in an axial direction of the cylinder, and is configured to transmit or shut-off the rotational force to the cylinder upon the axial movement.

5. The drilling device as claimed in claim 4, further comprising:
a trigger configured to turn on/off a power supply to the motor;
a switch configured to change an operation mode to the forward /reverse mode; and
a change-over dial configured to selectively provide one of an impact mode, a rotation mode, and an impact/rotation mode, in the impact mode only an impacting force being transmitted to the end bit by the reciprocal motion translating portion, in the rotation mode only a rotational force being transmitted to the end bit by the rotary motion transmitting portion, and in the impact/rotation mode the impacting force and the rotational force being transmitted to the end bit;
wherein the motor is operated in the forward/reverse mode by manipulating the switch and pulling the trigger while the change-over dial is at the rotation mode.

6. The drilling device as claimed in claim 4, further comprising a change-over dial configured to selectively change an operation mode to one of an impact mode, a rotation mode, an impact/rotation mode, and a forward/reverse mode, in the impact mode only an impacting force being transmitted to the end bit by the reciprocal motion translating portion, in the rotation mode only a rotational force being transmitted to the end bit by the rotary motion transmitting portion, and in the impact/rotation mode the impacting force and the rotation force being transmitted to the end bit.

7. The drilling device as claimed in claim 1, wherein the housing includes a main body portion accommodating therein the motor and the rotary motion transmitting portion, and a handle portion movable relative to the main body portion; and the drilling device further comprising:
a detecting portion configured to detect movement of the handle portion; and
a controller configured to set the operation mode to the forward/reverse mode in accordance with a result of detection by the detecting portion.

8. The drilling device as claimed in claim 7, wherein the detecting portion comprises a load sensor.

9. The drilling device as claimed in claim 7, wherein the detecting portion comprises a position sensor.

10. The drilling device as claimed in claim 1, wherein the motor is a brushless motor.
